(19) United States
(12) Patent Application Publication
(10) Pub. No.: US 2026/0213919 A1
(43) Pub. Date: Jul. 23, 2026

(54) SYSTEMS AND METHODS FOR SECURE LINEAR OPERATIONS IN MACHINE LEARNING VIA HOMOMORPHIC AGGREGATES

(71) Applicants: Constructor Technology AG, Schaffhausen (CH); Constructor Education and Research Genossenschaft, Schaffhausen (CH)

(72) Inventors: Alexander Tormasov, Büsingen am Hochrhein (DE); Serg Bell, Singapore (SG); Stanislav Protasov, Singapore (SG); Nikolay Dobrovolskiy, Alanya (TR); Laurent Dedenis, Geneve (CH)

(21) Appl. No.: 19/577,457

(22) Filed: Mar. 25, 2026

Related U.S. Application Data
(63) Continuation-in-part of application No. 19/399,724, filed on Nov. 25, 2025.
Application No. 19/399,724 is a continuation of application No. 19/169,111, filed on Apr. 3, 2025, now Pat. No. 12,500,735.
(60) Provisional application No. 63/575,099, filed on Apr. 5, 2024.

(51) Int. Cl. H04L 9/00; G06F 17/16; G06F 21/60; G06F 21/62; G06N 20/00; H04L 9/08; H04L 9/14; H04L 9/32; H04L 9/40

(52) U.S. Cl. CPC H04L 9/008; G06F 17/16; G06F 21/602; G06F 21/6218; G06F 21/6227; G06N 20/00; H04L 9/0819; H04L 9/14; H04L 9/3213; H04L 63/0478; G06F 2221/2141

(57) ABSTRACT

A system obtains a weight matrix associated with a linear operation, the weight matrix comprising a first non-zero value and a second non-zero value that is a negative value. The system decomposes the weight matrix into a first binary matrix indicating positions of the first non-zero value and a second binary matrix indicating positions of the second non-zero value. The system encrypts vector elements of an input vector using an encryption scheme to obtain an encrypted input vector. For each row of the first and second binary matrices, the system homomorphically processes selected encrypted elements of the encrypted input vector to generate at least two intermediate encrypted aggregates corresponding to respective contribution signs. The system generates an output element for each row based on a combination of the intermediate encrypted aggregates.

### CROSS-REFERENCE TO RELATED APPLICATIONS

This application is a continuation-in-part application that claims priority to U.S. Non-Provisional application Ser. No. 19/399,724, filed Nov. 25, 2025, which is a continuation-in-part application that claims priority to U.S. Non-Provisional application Ser. No. 19/169,111, filed Apr. 3, 2025, which further claims the benefit of U.S. Provisional Application No. 63/575,099, filed Apr. 5, 2024, all of which are herein incorporated by reference.

### FIELD OF TECHNOLOGY

The present disclosure relates to the field of machine learning (ML), and more specifically to partially homomorphic encryption (PHE)-compatible decomposition of ternary 1-bit weight matrices for secure distributed machine learning model (MLM) inference.

### BACKGROUND

Deploying large machine learning models in distributed client-server settings presents a tension between computational efficiency and data privacy when executing linear layers over sensitive inputs. Conventional homomorphic approaches that rely on general multiplication are often impractical for large-scale inference due to computational overheads, while schemes limited to homomorphic addition historically struggled to faithfully implement matrix-vector products with signed weights without resorting to costly multiplications or non-additive primitives. This problem is acute in 1-bit large language models (LLMs) and related machine learning models (MLMs), where linear layers frequently use ternary weight matrices with entries in {−1, 0, +1}, necessitating a secure and additive-only realization of the underlying linear algebra for feasible remote inference.

### SUMMARY

To address the issues previously described, the disclosed techniques improve secure execution of linear operations of a machine learning model (MLM) with ternary 1-bit weights in a distributed client-server architecture using partially homomorphic encryption (PHE).

In a high-level description of the systems and methods, weights of at least one linear operation are represented as a matrix whose elements take values in {−1, 0, +1}. The matrix is decomposed into two binary (0/1) matrices: a first matrix indicating positions of positive weights and a second matrix indicating positions of negative weights. For a given input vector encrypted under an encryption scheme that supports homomorphic addition, a server homomorphically computes two encrypted sums: a first encrypted sum corresponding to positions of positive weights and a second encrypted sum corresponding to positions of negative weights.

An output element for each row of the original matrix is obtained as a difference between contributions of the positive and negative weights. Depending on the capabilities of the PHE scheme, this difference is computed either (i) as an encrypted difference homomorphically on the server and then decrypted at a client device, or (ii) by decrypting the two encrypted sums at the client device and subtracting the resulting plaintext values. In both cases, matrix-vector multiplication with ternary 1-bit weights is implemented using only additions and subtractions, with no homomorphic multiplications, enabling efficient and privacy-preserving inference in 1-bit large language model (LLM) deployments.

By separating positive and negative contributions and restricting server-side processing to homomorphic addition and optional homomorphic negation, the method removes the need for homomorphic multiplications while preserving correctness of the ternary-weighted matrix-vector product. Positions corresponding to zero weights incur no homomorphic operations, further improving efficiency. This design supports secure distributed inference in which the server never observes plaintext inputs or outputs, while the client maintains control of the private key and can perform subsequent non-linear operations locally or re-encrypt outputs for further linear processing.

In some aspects, the techniques described herein relate to a method for computing a linear operation of a machine learning model (MLM), the method including: obtaining a weight matrix associated with the linear operation, the weight matrix including a plurality of weight elements including a first non-zero value and a second non-zero value that is a negative of the first non-zero value; decomposing the weight matrix into: a first binary matrix having elements that indicate positions of the first non-zero value in the weight matrix; and a second binary matrix having elements that indicate positions of the second non-zero value in the weight matrix; encrypting, using an encryption scheme, a plurality of vector elements of an input vector associated with the linear operation to obtain an encrypted input vector; for each respective row of the first binary matrix and the second binary matrix, homomorphically processing, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and generating an output element corresponding to the respective row based on a combination of the at least two intermediate encrypted aggregates.

In some aspects, the techniques described herein relate to a method, wherein homomorphically processing the encrypted elements includes for each respective row of the first binary matrix and the second binary matrix: homomorphically summing, using the encryption scheme, encrypted elements of the encrypted input vector selected according to elements of the first binary matrix that indicate positions of the first non-zero value, to obtain a first encrypted sum; and homomorphically summing, using the encryption scheme, encrypted elements of the encrypted input vector selected according to elements of the second binary matrix that indicate positions of the second non-zero value, to obtain a second encrypted sum.

In some aspects, the techniques described herein relate to a method, wherein obtaining the output element corresponding to the respective row includes: computing, using the encryption scheme, an encrypted subtraction between the first encrypted sum and the second encrypted sum; and decrypting the encrypted subtraction.

In some aspects, the techniques described herein relate to a method, wherein computing the encrypted subtraction includes: computing a homomorphic negation of the second encrypted sum using the encryption scheme; and homomorphically adding the first encrypted sum and the homomorphic negation of the second encrypted sum using the encryption scheme.

In some aspects, the techniques described herein relate to a method, wherein homomorphically summing to obtain the first encrypted sum and the second encrypted sum and computing of the encrypted subtraction are performed on at least one server; and decrypting of the encrypted subtraction is performed on at least one client device that stores a private key associated with the encryption scheme.

In some aspects, the techniques described herein relate to a method, wherein the combination of the at least two intermediate encrypted aggregates is a difference between aggregates corresponding to positive and negative contribution signs.

In some aspects, the techniques described herein relate to a method, wherein the encryption scheme is a partially homomorphic encryption (PHE) scheme.

In some aspects, the techniques described herein relate to a method, wherein the PHE scheme is based on a Paillier cryptosystem, and homomorphically processing includes repeated application of an addition operation defined by the Paillier cryptosystem to ciphertexts corresponding to elements of the encrypted input vector.

In some aspects, the encryption scheme is based on a Cheon-Kim-Kim-Song (CKKS) encryption scheme.

In some aspects, the encryption scheme is Torus Fully Homomorphic Encryption (TFHE) scheme.

In some aspects, the techniques described herein relate to a method, wherein: the elements of the weight matrix include values in {−1, 0, +1}, wherein the first non-zero value is +1, the second non-zero value is −1, and wherein: the first binary matrix has an element equal to one where the weight matrix has an element equal to +1, and zero otherwise; and the second binary matrix has an element equal to one where the weight matrix has an element equal to −1, and zero otherwise.

In some aspects, the techniques described herein relate to a method, wherein the MLM is a 1-bit large language model (LLM), and the weight matrix represents weights of a 1-bit linear layer of the 1-bit LLM.

In some aspects, the techniques described herein relate to a method, further including omitting homomorphic summing of encrypted elements of the encrypted input vector for positions in a row of the weight matrix where corresponding elements of the first binary matrix and the second binary matrix each indicate absence of the first non-zero value and the second non-zero value.

In some aspects, the techniques described herein relate to a method, further including: performing at least one non-linear operation of the MLM on one or more output elements obtained on a client device without using the encryption scheme; and providing a result of the at least one non-linear operation as an input to a subsequent operation of the MLM.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for computing a linear operation of a machine learning model (MLM), including: at least one memory; and at least one hardware processor coupled with the at least one memory and configured, individually or in combination, to: obtain a weight matrix associated with the linear operation, the weight matrix including a plurality of weight elements including a first non-zero value and a second non-zero value that is a negative of the first non-zero value; decompose the weight matrix into: a first binary matrix having elements that indicate positions of the first non-zero value in the weight matrix; and a second binary matrix having elements that indicate positions of the second non-zero value in the weight matrix; encrypt, using an encryption scheme, a plurality of vector elements of an input vector associated with the linear operation to obtain an encrypted input vector; for each respective row of the first binary matrix and the second binary matrix, homomorphically process, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and generate an output element corresponding to the respective row based on a combination of the at least two intermediate encrypted aggregates.

In some aspects, the techniques described herein relate to a non-transitory computer readable medium storing thereon computer executable instructions for computing a linear operation of a machine learning model (MLM), including instructions for: obtaining a weight matrix associated with the linear operation, the weight matrix including a plurality of weight elements including a first non-zero value and a second non-zero value that is a negative of the first non-zero value; decomposing the weight matrix into: a first binary matrix having elements that indicate positions of the first non-zero value in the weight matrix; and a second binary matrix having elements that indicate positions of the second non-zero value in the weight matrix; encrypting, using an encryption scheme, a plurality of vector elements of an input vector associated with the linear operation to obtain an encrypted input vector; for each respective row of the first binary matrix and the second binary matrix, homomorphically processing, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and generating an output element corresponding to the respective row based on a combination of the at least two intermediate encrypted aggregates.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1A is a block diagram of an exemplary secure local LLM deployment in an enterprise.

FIG. 1B is a block diagram of an exemplary secure hosted LLM deployment for an enterprise.

FIG. 2 is a block diagram of exemplary functional modules of the secure LLM deployment for an enterprise.

FIG. 3 illustrates a method for providing a secure LLM deployment in an enterprise.

FIG. 4 illustrates an example of a method for providing a secure LLM deployment in an enterprise using encryption and Access Control List (ACL).

FIG. 5 is a block diagram of an encoder and decoder-based architecture on which encryption is performed.

FIG. 6 is a block diagram of a multi-head attention block.

FIG. 7 is a block diagram of a generalized example for performing LLM operations using a client device and a service provider.

FIG. 8 illustrates another method for securely executing an MLM.

FIG. 9 illustrates a client-server system for secure inference of an MLM using partially homomorphic encryption (PHE), in which ternary weight matrices are decomposed into binary matrices and linear operations on encrypted data are computed via homomorphic addition.

FIG. 10 illustrates a method for secure inference of an MLM using partially homomorphic encryption (PHE), in which ternary weight matrices are decomposed into binary matrices and linear operations on encrypted data are computed via homomorphic addition.

FIG. 11 presents an example of a general purpose computer system on which aspects of a secure LLM deployment in an enterprise can be implemented.

### DETAILED DESCRIPTION

Exemplary aspects are described herein in the context of a system, method, and a computer program for providing a secure large language model (LLM) deployment in an enterprise IT environment. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

In an exemplary aspect, a method for secure distributed processing of data is provided. The method comprises determining whether a first operation of a distributed machine learning model should be executed on at least one server or on at least one client device based on one or more criteria including compatibility with specific encryption schemes, computational load distribution, and associated expense considerations. In response to a determination that the first operation should be executed on the at least one server, the method further comprises encrypting data associated with the first operation using a specific encryption scheme and transmitting the encrypted data to the at least one server for execution of the first operation on the encrypted data. In response to a determination that the first operation should be executed on the at least one client device, the method comprises performing the first operation on the data using the at least one client device without encrypting the data using the specific encryption scheme.

The method enables explicit control over placement of computational load between server-side and client-side resources, allowing selection of execution location to reflect encryption compatibility, throughput requirements, latency constraints, energy consumption preferences, and cost models associated with network transfer and compute usage. Encryption of server-bound data using the specific encryption scheme provides confidentiality during transit and server-side processing, while local execution on the at least one client device without application of the specific encryption scheme reduces overhead when encryption is unnecessary under the selected load distribution and cost profile. The method thereby facilitates secure, configurable, and cost-aware execution of distributed machine learning operations across heterogeneous infrastructure.

The present disclosure describes a secure 1-bit distributed LLM that offers security and computational efficiency. In general, a 1-bit LLM refers to a type of neural network model where the weights and possibly the activations are quantized to 1-bit precision. This means that instead of using the typical 32-bit or 16-bit floating-point numbers to represent the weights and activations, the model uses binary values (0 or 1). This quantization can significantly reduce the memory footprint and computational requirements of the model, making it more efficient in terms of storage and processing.

By using 1-bit precision, the amount of memory required to store the weights of the model is drastically reduced. This can be particularly beneficial for deploying large models on devices with limited memory, such as mobile phones or edge devices. The overall size of the model is also much smaller compared to traditional models with higher precision weights.

Furthermore, operations involving 1-bit values are generally faster and require less power compared to operations involving higher precision values. This can lead to faster inference times and lower energy consumption. The reduced precision can simplify the hardware requirements, allowing for the use of specialized hardware accelerators designed for binary operations.

In particular, 1-bit LLMs are well-suited for deployment on edge devices (e.g., client devices) where memory and computational resources are limited. This facilitates a distribution of the LLM. More specifically, the LLM architecture of the present disclosure is distributed between one or more client devices and one or more servers such that some operations of the LLM are executed on the client device(s) and some on the server(s). To address the security issues of conventional LLMs, data of certain operations of the LLM of the present disclosure are encrypted. In some aspects, the encryption is performed using partial homomorphic encryption (PHE). In some aspects, data of operations executed on the server are encrypted, whereas data of operations executed on the client device are unencrypted. This assures confidentiality of information without wasting resources on encryption where it is not needed (e.g., on a local client device).

In an exemplary aspect, all matrices of weights are represented in 1-bit format. In 1-bit format, there is no multiplication operation (because of data is binarized (−1,0,1) in INT8 format) and only addition operations and change of sign operations are performed. This makes matrix/vector operations on the matrices computationally faster than floating point matrix multiplication. In some aspects, input/output vector data is still represented in floating point format (FP16 format). Because PHE enables addition operations and does not conflict with 1-bit format, PHE may be used for encrypting certain data. The data associated with vector operations and other matrix operations that require multiplication and division is left unencrypted.

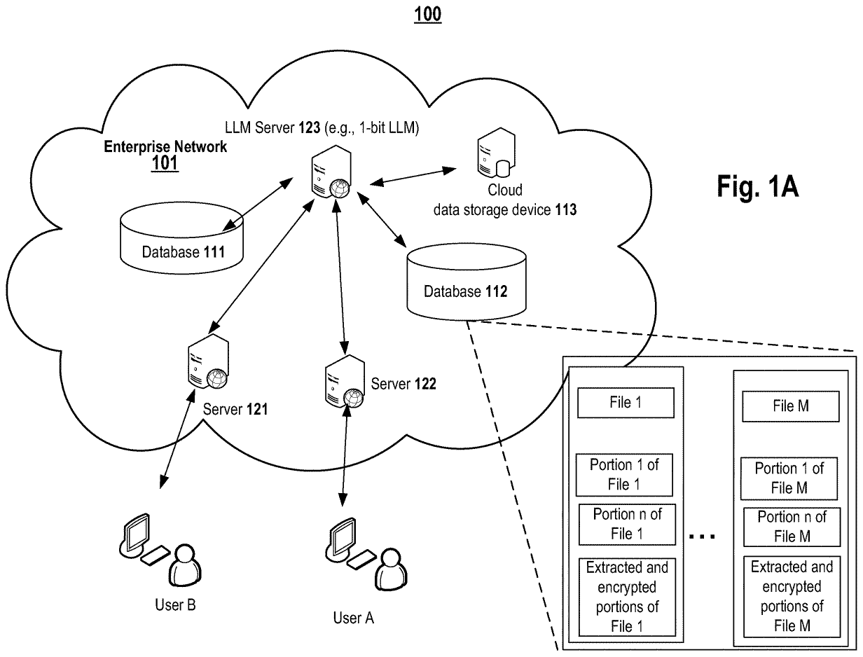

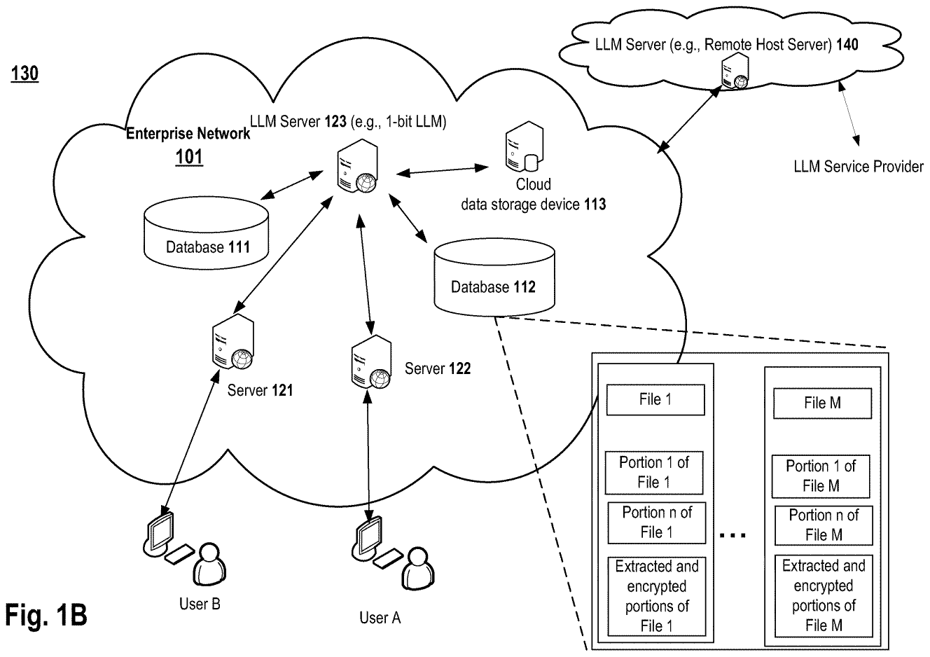

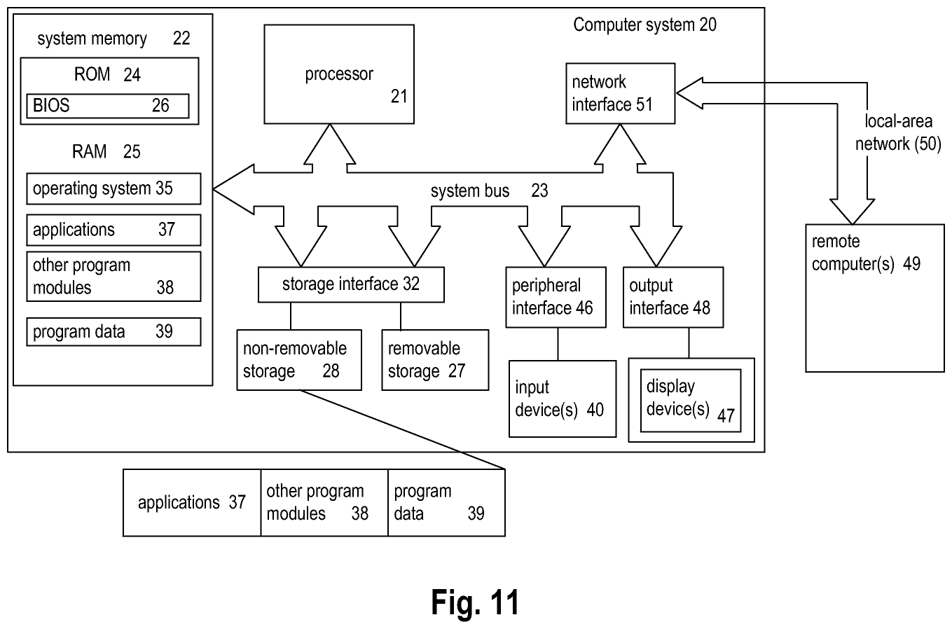

FIG. 1A illustrates a block diagram of an exemplary system 100 for providing a secure local LLM deployment in an enterprise network. In one aspect, the components of system 100 may be implemented on computer systems, such as that shown in FIG. 11.

In one aspect, system 100 includes an enterprise network 101 which includes at least servers 121-123. It is noted that system 100 includes any number of other network components and FIG. 1A only shows the components relevant for the illustrative example of the present disclosure. Users of the enterprise network 101 (e.g., employees or customers) communicate with devices in the enterprise network 101 via one of the servers, e.g., user A communicates with components of the enterprise network 101 via server 122, and user B communicates with components of the enterprise network 101 via server 121. Notably, certain operations of the 1-bit LLM of the present embodiment are implemented on LLM server 123.

In addition, enterprise network 101 includes any number of database servers, such as the database servers 111 and 112. In one aspect, data of the enterprise network may also be stored on a cloud storage device, such as the storage device 113 (also referred to as database server 113). Thus, files of the enterprise network may be stored in any of the database servers 111-113. For example, files 1-M, are shown as being stored on the database server 112. In one aspect, the files 1-M may contain any number of portions of data, with some portions being confidential data. Thus, at least some of the portions of the files 1-M may also be encrypted and stored on any of the database servers 111-113.

FIG. 1B illustrates a block diagram of an exemplary system 130 for providing a secure hosted LLM deployment on a remote server 140 for an enterprise. Thus, the system 130 is for the scenario in which the enterprise network accesses LLM functionality from a service provider (e.g., cloud service provider) rather than deploying the functionality on a server of the enterprise.

In one aspect, the system 130 includes an enterprise network 101 which includes at least servers 121-123. The enterprise network 101 is communicatively coupled to an LLM service provider network 102 for accessing LLM functionalities. That is, rather than deploying all of the LLM functionality on the enterprise network 101, the enterprise subscribes to the LLM functionality from a service provider. Users of the enterprise network 101 communicate with devices in the enterprise network 101 via one of the servers, e.g., user A communicates with components of the enterprise network 101 via server 122, and user B communicates with components of the enterprise network 101 via server 121. The LLM of service provider is implemented on the server 140 located in the LLM service provider's network 102.

To enable enterprise employees to use LLM services to intelligently search and query data files and documents stored in the enterprise database, in one exemplary aspect, the LLM server 140 may be configured to operate on the encrypted confidential data of the enterprise network 101. Particularly, in one aspect, the LLM server 140 may be configured to perform LLM training, LLM fine-tuning, and LLM inference (and any other required operations) using the encrypted data without being able to decrypt it, which provides a high-degree of security to the enterprise data. Thus, the 1-bit LLM functionality installed on LLM server 140 has no access to encrypted versions of the confidential data. Moreover, in another example aspect, the user prompts may also be encrypted to allow an even greater degree of confidentiality.

In another aspect where the LLM service provider is a trusted service provider and can have access to unencrypted data, the LLM server 140 accesses data stored in the database servers 111-113, and performs all LLM operations including the encrypting of the content stored on the database servers 111-113. In this scenario, the training, retraining, and fine-tuning of the LLM may be performed by the trusted service provider.

In one of the scenarios, a Large Language Model (LLM) is deployed on the service side in encrypted mode. The user wants to interact with the LLM while keeping the query and answer encrypted. In this case, the query is encrypted using Partially Homomorphic Encryption (PHE) and sent to the service side. The LLM processes this query using addition operations in PHE mode, generates results from these operations, and sends the results back to the user. The user then decrypts the results from the service, performs complex operations on their side, encrypts their results, and sends them again to the service. This back-and-forth exchange allows the service side to manage the bulk of the addition operations, which are the most frequent and thus computationally consuming. Ultimately, the user obtains the final result, while most of the computational load remains on the service side. However, the service does not have access to the query, response, or intermediate results, as they are encrypted and processed in PHE mode. Consequently, the service remains unaware of the details of the query and response.

In one embodiment between the service and user, there is a gateway that can transform PHE to standard encryption, allowing the user to decipher using light standard encryption. There is also a gateway that can work in the opposite direction.

For an illustrative non-limiting example, suppose the enterprise network comprises a hospital network with users having access to different portions of data stored in various databases of the hospital. In one aspect, the hospital may obtain LLM services from a trusted service provider. The trusted service provider may then access the data, encrypt the data as needed, set up access lists (if applicable) for various groups of users (e.g., doctors, nurses, administrators, IT personal, etc.), provide decryption keys to users allowed to access certain portions of data, etc. For example, portions of the medical records containing patients'names may be encrypted, but the information about patient's medical condition, treatment protocols and the results of the treatment may remain unencrypted. The LLM may be trained on these partially encrypted filed. When a query is received from a user for an LLM service (e.g., search for information about successful treatment of a particular medical condition), after authenticating the user and checking his access level, the inference module of the LLM server may generate a response to the user prompt. For example, the LLM, which was trained on the patient records, may identify successful treatment cases and summarize conditions of patients and their treatment protocols without revealing patients'names if users access level prohibits access to this information.

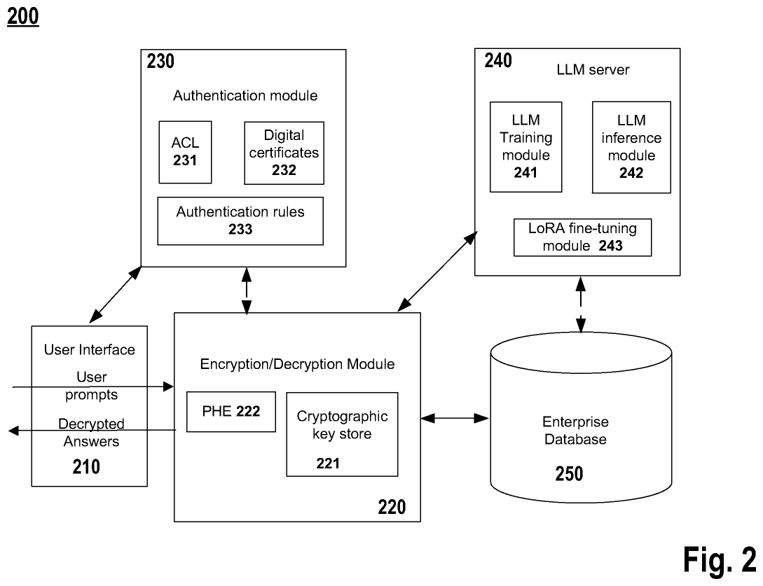

FIG. 2 is an example of a block diagram of functional modules of the system 200 for secure LLM deployment for an enterprise according to one exemplary aspect. Some of these functional modules may be deployed locally on the servers of the enterprise network 101 or hosted on a remote server such as server 140. In one example aspect, the system 200 includes the following functional modules: a user interface 210, an encryption/decryption module 220, an authentication module 230, an LLM server 240, and enterprise databases 250.

In one aspect, the user interface 210 is designed to enable user endpoint devices to access enterprise's LLM functionality in a secure and confidential manner. User interface 210 may be implemented as web-based interface or a desktop application. The user interface 210 allows users to use text prompts to perform text-based searches for documents in enterprise database 250, to query the LLM server 240 for answers to specific questions related to the documents and files stored in the enterprise database 250, or, depending on the natural language processing capabilities of the LLM server 240, to simulate a conversation with the LLM server 240 on topics related to the documents contained in the database 250 or other topics on which the LLM server 240 has been trained to answer. In one aspect, the access to the LLM services and/or to confidential documents in the enterprise database 250 is allowed to authenticated users only and/or users who have an appropriate level of access (e.g., doctors, administrators, IT staff, etc.).

In one aspect, the authentication module 230 is provided to enable authentication of users that access LLM services of the enterprise via the interface 210. In one example, the authentication may be performed using an Access Control List (ACL) 231, identifying individual users and their respective access level to documents in the enterprise database. In another example, the authentication can be performed using cryptographic techniques, such as digital certificates 232 associate with individual users. Yet in another example, various authentication rules 233 may be used to specify the access level of individual users or groups/categories of users, what confidential data is accessible to the users, whether user's LLM prompts should be encrypted, etc. Alternatively, a combination of these and other known authentication techniques may be used.

For example, if a user query does not include the key(s) associated with an authorized user (as indicated in ACL 231), basic unencrypted LLM data and matrices are used. If the keys are provided, depending on the level of access, whole matrices and LLM data with both encrypted and encrypted data may be used. In some aspects, different LLMs are trained, each with a different amount of access to data. For example, a limited LLM may be able to provide simple answers without confidential data. A full LLM may provide more advanced answers for users having access keys.

In order to access LLM services external to the enterprise while maintaining the security of user prompts and confidential enterprise data, the enterprise may encrypt its confidential data using homomorphic encryption that allows LLM server 240 to perform operations on the encrypted data without decryption thereof. In one example, the encryption/decryption module 220 is deployed on a server in the enterprise network 101 and configured to perform encryption/decryption of confidential data using PHE 222. An advantage of using PHE is that it is more efficient than FHE in terms of computational load, particularly for 1-Bit LLM implementations.

Furthermore, since homomorphic encryption used by the module 220 is a form of asymmetric encryption algorithm that uses private/public key pairs for encryption and decryption of data files, module 220 may store all generated cryptographic key pairs in a datastore 221. Furthermore, since module 220 may be also configured to encrypt user prompts, which provides an extra level of security and confidentiality to the enterprise, the cryptographic keys generated for each user to encrypt his/her prompts are also stored in the datastore 221.

PHE is a cryptographic technique that enables specific types of computations on encrypted data while maintaining its confidentiality. Unlike FHE, which allows arbitrary computations on encrypted data, PHE supports only certain operations (e.g., addition, multiplication—but not both simultaneously). Accordingly, when matrix operations involving addition or multiplication are performed by an LLM to generate outputs, the operations remain successful and generate proper results despite the encryption. In another example, suppose that the LLM is trained on a document that states “Mary was born on Jan. 1, 1990.” If the birthdate is encrypted (suppose that the encrypted value generated using an encryption key is 123432), the modified document may state “Mary was born on 123432.” The LLM may be trained using this modified document, which prevents the actual birthdate from being leaked/stolen. The trained LLM may generate an output stating “Mary's birthdate is 123432” to a user query “what is Mary's birthdate?”. Here, the output includes the encrypted value of the birthdate. A user with a decryption key may be able to generate the statement “Mary's birthdate is Jan. 1, 1990” using this key.

In some aspects, the PHE used in the present disclosure may be the Paillier cryptosystem, which supports addition operations on encrypted values. This means that one can perform additions on ciphertexts without decrypting them first. PHE is valuable in scenarios where specific computations need to be performed on sensitive data while it remains encrypted, such as in privacy-preserving computations in the cloud or secure multi-party computations. By allowing limited operations on encrypted data, PHE strikes a balance between data utility and confidentiality, enabling practical applications of secure computation in various domains, including finance, healthcare, and decentralized systems. In some aspects, PHE schemes can be performed with a pair of keys based on, for example, RSA (a public-key cryptosystem). In other aspects, PHE schemes can be performed with a single key based on, for example, the Paillier cryptosystem.

In one example aspect, the system 200 further comprises an LLM server 240 that executes an LLM program. The LLM server 240 may be deployed on a local enterprise server, as shown in FIG. 1A, or on a remote host server, as shown in FIG. 1B. The LLM server 240 includes a LLM training module 242, LLM inference module 242, and LLM fine-tuning module 243. The training module 241 is configured to train LLM on files stored in enterprise database. In one aspect, an LLM may be trained both on the unencrypted files that do not contain any confidential data and encrypted files that contain confidential data. In another aspect, LLM may be pretrained using unencrypted files, and then finetuned by module 243 using encrypted files. Notably, PHE encryption allows LLM training, finetuning, and inference to be performed on the encrypted files. Particularly, matrix-vector mathematical operations can be performed on the encrypted data. This allows enterprise to use LLM services while maintaining the secrecy of the confidential data.

In one aspect, fine-tuning module 243 may implement Low-Rank Adaptation (LoRA) algorithm, which provides high-efficiency LLM optimization. For example, prompts and corresponding responses (e.g., samples from historical data) may be used for fine-tuning the LLM for a specific task. The fine-tuning using the LoRA technique involves differentiating new elements that are not well represented in previous training sets of data and modified elements that are recognized, but not adequately represented in previous training sets of data, and then modifying a small portion of weights of the model for performing the fine-tuning. Thus, the weights of the model affected by the new elements and modified elements are changed to improve the accuracy of the LLM training. In one aspect, the LoRA fine-tuning module 243 of the present disclosure is used to further optimize the performance on the PHE encrypted data. LoRA-related data may be stored separately and be encrypted, e.g., by the PHE algorithm, in the same way as described above.

In terms of training, the LLM may be trained through a process called unsupervised learning on a large dataset comprised of text from across various sources (e.g., webpages, documents, articles, etc.). The training begins by initializing the model with random parameters. The LLM then processes sequences of text, ranging from a few words to entire paragraphs, predicting the next word in each sequence. These predictions are compared to the actual next words in the dataset, and the model adjusts its parameters to minimize the difference between its predictions and the actual text. This process, known as backpropagation, is repeated iteratively over several (millions or possibly billions) text examples, allowing the model to learn intricate patterns, grammar rules, contextual understanding, and semantic relationships. The model's objective during training is to maximize the likelihood of generating the correct next word given a sequence of previous words. Additionally, fine-tuning techniques may be applied to adapt the model to specific tasks or domains, further enhancing its performance and applicability. Through this iterative process, the LLM gradually develops a nuanced understanding of language and can generate coherent and contextually appropriate responses to a wide range of queries.

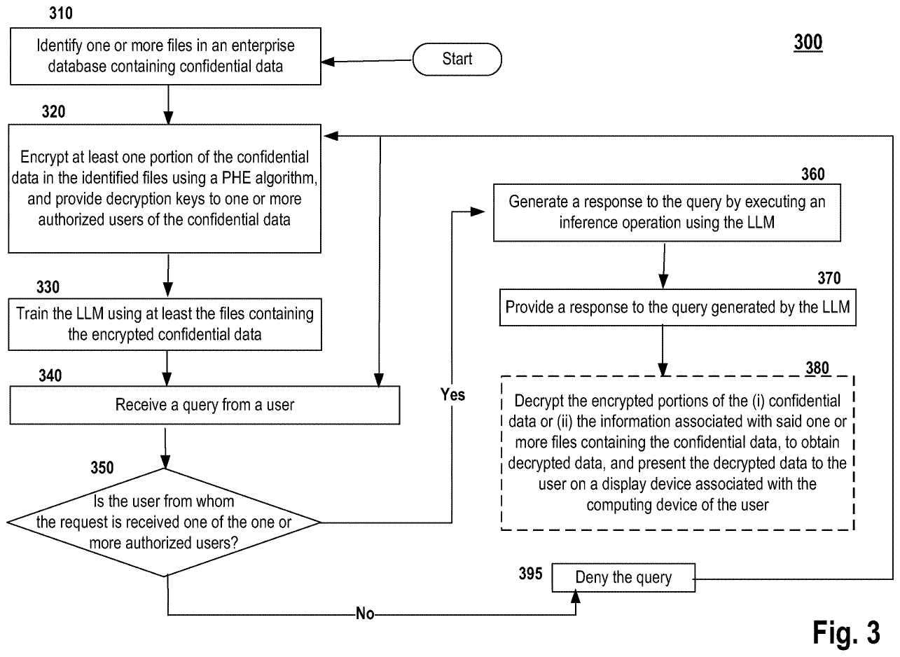

FIG. 3 illustrates a method 300 for providing a secure LLM deployment in an enterprise in accordance with aspects of the present disclosure. In step 310, method 300 identifies one or more files in an enterprise database containing confidential data. The enterprise database is configured to limit access to the confidential data based on an encryption of the confidential data.

In one aspect, the limit to the access to the confidential data is further based on a user's access level. For example, user A may have a different access level from user B. Moreover, based on their respective roles in the enterprise, users A and B may have different needs for accessing different portions of the confidential data. For instance, if the enterprise is a hospital, doctors, nurses, patients, hospital administrators, IT personal etc., would have differing needs for accessing confidential data. Thus, an access control list (ACL) may be used to facilitate compliance to established policies and regulations. The ACL may be implemented on any of the servers of the enterprise. Gateway devices communicating with users may then access the ACL to determine whether access to confidential data is to be granted to a particular user. As mentioned above, a user may be granted access to specific portions of confidential data.

Thus, in one aspect, the determination of whether the user from whom the request is received is one of the one or more authorized users is further based on an ACL of the enterprise.

In step 320, by a server, method 300 encrypts at least one portion of the confidential data in the identified files using a partial homomorphic encryption (PHE) algorithm, and provides decryption keys to one or more authorized users of the confidential data.

In one aspect, the encrypting of the at least one portion of the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In step 330, by the server, method 300 trains the LLM using at least the files containing the encrypted confidential data. Once the training of the LLM is completed, the LLM server is ready to respond to prompts by performing an inference operation.

In one aspect, the LLM is a 1-bit LLM where an operation of multiplication of matrix to vector is efficiently replaced by changes of sign and addition.

In one aspect, the training of the LLM comprises: taking a LLM partially trained at least on files from enterprise database that do not contain any confidential data; and completing the training using the files containing the encrypted confidential data.

In step 340, by the server, method 300 receives a query from a user, wherein the query comprises a request (i) for searching for the one or more files containing the confidential data or (ii) for obtaining information associated with said one or more files.

In step 350, by the server, method 300 determines whether the user from whom the request is received is one of the one or more authorized users of (i) the one or more files containing the confidential data or (ii) the information associated with said one or more files containing the confidential data. When the user from whom the request is received is one of the one or more authorized users, the method proceeds to step 360. When the user from whom the request is received is not one of the authorized users, the method proceeds to step 395.

In one aspect, the determination of whether the user from whom the request is received is one of the one or more authorized users, includes: identifying one or more files associated with the query received from the user; for each identified file associated with the query received from the user which is among the one or more files containing the confidential data, applying the ACL of the enterprise; and generating the response by executing the inference operation only on the one or more files for which the user's access level is determined as being sufficient.

In step 360, by the server, method 300 generates a response to the query by executing an inference operation using the LLM. For example, the server may prompt an LLM server for a response to the query.

In one aspect, the LLM operation may be implemented on the same server as the server interacting with the user. In another aspect, the server interacting with the user is distinct from the server performing the LLM operations.

In one aspect, the LLM is deployed on a server located in the network of the enterprise. In another aspect, the LLM is deployed on a remote server, which may be a cloud server or a server of a service provider providing LLM functionality to the enterprise.

In step 370, by the server, method 300 provides a response to the query generated by the LLM, wherein, when the response includes the at least one portion of the confidential data that is encrypted, the encrypted portion of the confidential data is decryptable using the decryption key provided to the user of the one or more authorized users.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data. For example, the prompt from the user is processed by the user interface 210 to generate a vector of features of the prompt. Then, the PHE 222 is used to encrypt the vector and send the resulting encrypted prompt to the LLM server 240. The LLM server 240 operates on the encrypted prompt to generate a response via the LLM inference module 242, and sends the generated response. Then, the response is decrypted by encryption/decryption module 220 and sent to the user interface 210.

In one aspect, the response to the query from the user includes at least encrypted portions of (i) confidential data or (ii) information associated with said one or more files containing the confidential data.

In one aspect, once the computing device of the user receives the response from the server, the computing device of the user decrypts the encrypted portions of the (i) confidential data or (ii) the information associated with said one or more files containing the confidential data, to obtain decrypted data. Then, the computing device of the user presents the decrypted data to the user on a display device associated with the computing device of the user.

Thus, in optional step 380, by the computing device of the user, method 300 decrypts the encrypted portions of the (i) confidential data or (ii) the information associated with said one or more files containing the confidential data, to obtain decrypted data; and presents the decrypted data to the user on a display device associated with the computing device of the user. The method then proceeds to step 320 and/or 340 to continue encrypting newly received confidential data and/or receive queries from users.

In step 395, by the server, method 300 provides a response to the query denying the request. The method then proceeds to step 320 and/or 340 to continue encrypting newly received confidential data and/or receive queries from users.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises: executing steps without decrypting the at least one portion of the confidential data that is encrypted, at least for one of: inference operations, training of algorithms, retraining of algorithms, data preparation and specialization of the algorithm for a specific application.

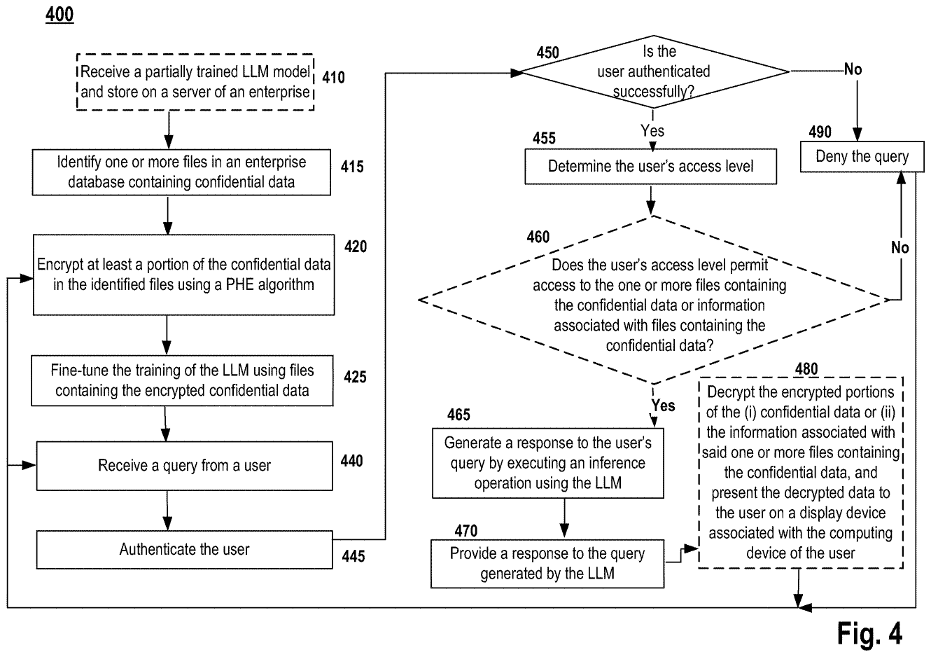

As described above, during execution of the steps of method 300, the enterprise database is configured to limit access to the confidential data based on an encryption of the confidential data. However, the ACL was an optional feature. The usage of the ACL when it is not optional is further described below in conjunction with FIG. 4. Method 300 mainly uses encryption techniques for data security by providing the decrypting keys only to authorized users. Thus, users of the enterprise network may be provided different decryption keys for accessing different portions of confidential data. Alternatively, a method for providing the secure LLM may use both the encryption and the ACL in an integrated manner.

FIG. 4 illustrates an example of a method 400 for providing a secure LLM deployment in an enterprise using encryption and Access Control List (ACL) in accordance with aspects of the present disclosure.

In optional step 410, method 400 receives a partially trained LLM algorithm and stores the partially trained LLM on a server, e.g., a server of the enterprise.

In step 415, method 400 identifies one or more files in an enterprise database containing confidential data. The enterprise database is configured to limit access to the confidential data based on an encryption of the confidential data and usage of ACL.

In step 420, by a server, method 400 encrypts at least one portion of the confidential data in the identified files using a PHE algorithm, and provides decryption keys to one or more authorized users of the confidential data.

In step 425, by a server, method 400 fine-tunes the trained LLM using files containing the encrypted confidential data.

In step 440, by the server, method 400 receives a query from a user, wherein the query comprises a request (i) for searching for the one or more files containing the confidential data or (ii) for obtaining information associated with said one or more files.

In step 445, by the server, method 400 authenticates the user.

In step 450, by the server, method 400 determines whether the user is authenticated successfully. When the user is authenticated successfully, method 400 proceeds to step 455. Otherwise, the method proceeds to step 490.

In step 455, by the server, method 400 determines the access level of the user from whom the query is received.

In step 460, by the server, method 400 determines whether the access level of the user permits access to the one or more files containing the confidential data or (ii) the information associated with said one or more files containing the confidential data. When the access level of the user permits access to the confidential data or (ii) information associated with said one or more files, method 400 proceeds to step 465. When the access level of the user does not permit access to the confidential data or (ii) for obtaining information associated with said one or more files, method 400 proceeds to step 490.

In step 465, by the server, method 400 generates a response to the query by executing an inference operation using the LLM.

In step 470, by the server, method 400 provides a response to the query generated by the LLM, wherein, when the response includes the at least one portion of the confidential data that is encrypted, the encrypted portion of the confidential data is decryptable using the decryption key provided to the user of the one or more authorized users.

In optional step 480, by the computing device of the user, method 400 decrypts the encrypted portions of the (i) confidential data or (ii) the information associated with said one or more files containing the confidential data, to obtain decrypted data; and presents the decrypted data to the user on a display device associated with the computing device of the user.

In step 490, method 400 denies the query. The method may then proceed to step 440 to receive more queries, or to step 420 to receive more data for encryption.

In one aspect, the LLM is a 1-bit LLM where an operation of multiplication of matrix to vector is efficiently replaced by changes of sign and addition.

In one aspect, the LLM is deployed on a local enterprise server.

In one aspect, the LLM is deployed on a remote host server.

In one aspect, encrypting at least the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In one aspect, the response to the user's query includes at least encrypted portions of (i) confidential data or (ii) information associated with said one or more files containing the confidential data.

In one aspect, the determination of whether the user's access level permits access to (i) the one or more files containing the confidential data or (ii) the information associated with said one or more files containing the confidential data, includes: identifying one or more files associated with the user's query; for each identified file associated with the user's query which is among the one or more files containing the confidential data, applying the ACL of the enterprise; and generating the response to the user's query by executing the inference operation only on the one or more files for which the user's access level is determined as being sufficient.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises executing steps without decrypting the at least one portion of the confidential data that is encrypted, at least for one of: inference operations, training of algorithms, retraining of algorithms, data preparation and specialization of the algorithm for a specific application.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data.

Integrating PHE into training a LLM involves encrypting the sensitive data involved in the training process, such as the training data itself, gradients, or model parameters.

In one aspects, training data is encrypted using PHE before being sent to the training server. This ensures that the data remains confidential throughout the training process. Techniques like additive or multiplicative homomorphic encryption can be used based on the specific operations required during training.

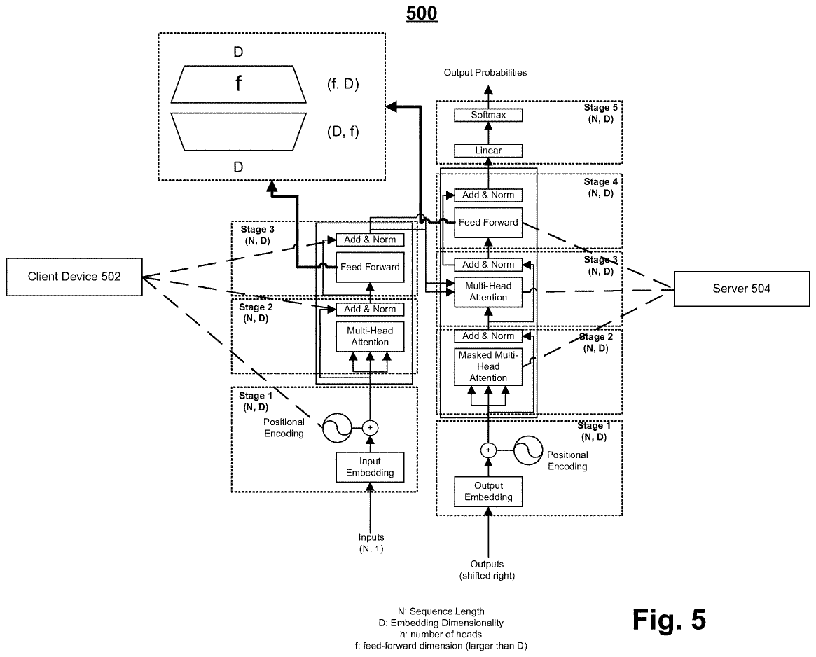

FIG. 5 is a block diagram of an encoder and decoder-based architecture 500 on which layer-specific encryption is performed. Architecture 500 significantly reduces memory footprint and energy consumption and can be effectively scaled to even larger language models with potential benefits in terms of performance and efficiency. Here, D represents embedding dimensionality and is a small vector, h is a number of heads and is also a small number, and f is a feed-forward dimension, which is a large matrix (implement feed-forward using 1-bit format). The system performs training on encrypted data and to generate 1-bit encrypted matrices.

An encoder is used to analyze user queries and a decoder is used to generate answers to the queries. The encoder may be stacked Nx layers high (multiple encoder layers) and likewise the decoder may be stacked Nx layers high. These layers are distributed over client device 502 (e.g., server 121) and server 504 (e.g., LLM server 140).

In architecture 500, all large weight matrices are in 1-bit format and therefore operations with those matrixes (e.g., linear, feed forward, matmul operations) are encrypted using PHE, and sent from client device 502 in secrecy for training or inference to server 504 hosting other layers of the architecture 500. In some aspects, vectors including embeddings or training data may be encrypted using PHE. Furthermore, operations on matrixes and vectors may be encrypted in PHE.

Architecture 500 is marked showing dimensionality of each stage. A typical transformer architecture includes stacks of attention and feed forward layers. In some aspects, there may be 12 layers.

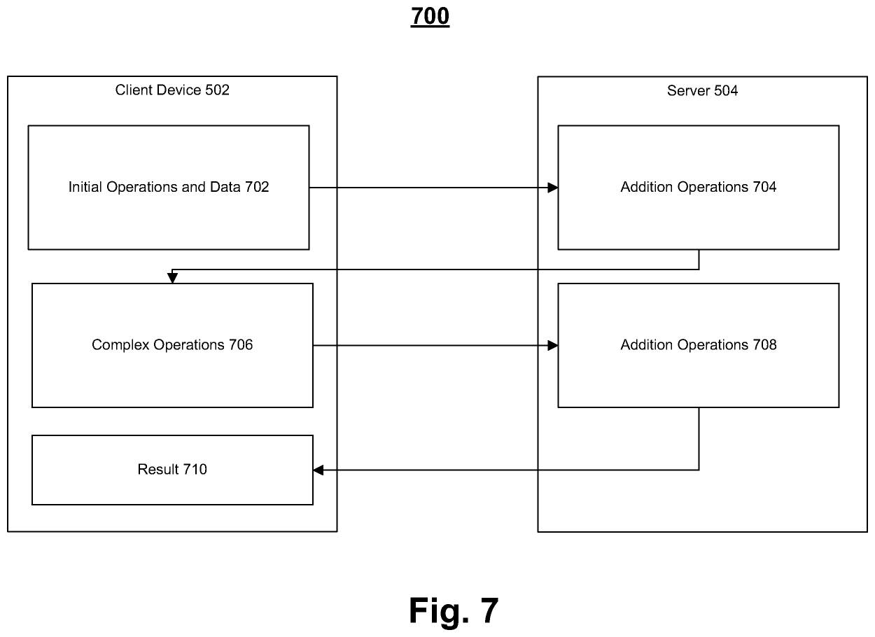

Linear, feed forward, matmul operations involve matrix-vector multiplication and addition and can be performed in 1-bit format. All other operations, which involve not only multiplication/additions, but other operations, such as normalization operation (e.g., Layernorm) which transforms all numbers in vectors to 0-1 range and involves division operation, and Scaled Dot-Product Attention (shown in FIG. 7), which also involves division and square root operation, cannot be performed in 1-bit format and cannot be PHE encoded. These, operations can be encrypted using other techniques or performed on the client device 502.

For example, in the architecture 500, the positional encoding block involves sin and cosine functions and division and therefore cannot be PHE encoded. Such encoding may be performed on the client device 502.

In another example, the vector input into a feed forward block at stage 3 may be PHE-encrypted by client device 502 and sent to server 504. All weight matrixes stored on the server 504 involving a feed forward operation may be in 1-bit format and PHE encrypted. The server 504 will perform the feed forward operation on the PHE-encrypted vector and PHE-encrypted matrixes, and return a PHE-encrypted result to the client device 502. The client device 502 will decrypt the received data and perform the Add&Norm operation of Stage 3. Then, the client device 502 may encrypt results using PHE and send it back to the server 504 to perform Multi-Head Attention at stage 3 (right-hand column of architecture 500). Masked Multi-Head attention is also performed using 1-bit architecture (where all weights are in 1-bit format).

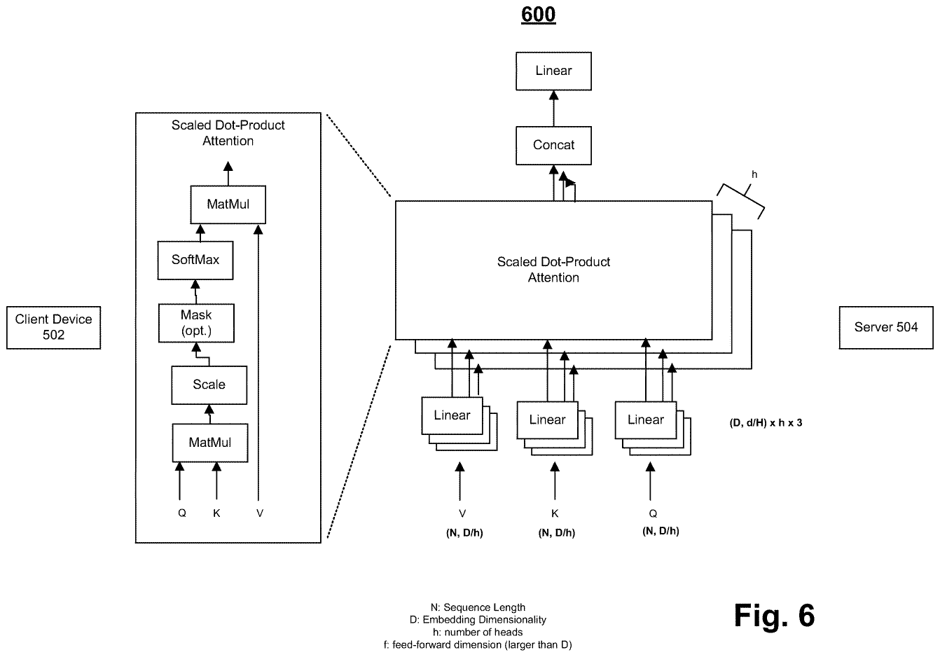

FIG. 6 is a block diagram of a multi-head attention block 600. In some aspects, Multi-Head Attention, which involves a linear operation followed by Scaled Dot-Product Attention, may also be split between the client device 502 and server 504. Linear operations can be performed on PHE encrypted 1-bit matrices, and Scaled Dot-Product Attention, which involves division and square root operation, can be performed on the client device 502 or in FHE encrypted from on the server 504. In fact, the Attention operation has low dimensionality and therefore is not computationally intensive and can be easily performed by the client device 502 in unencrypted form.

The scale block involves division and a square root function and is therefore not compatible with PHE. Softmax involves exponents and division. The Mask block is simply matrix addition and can be 1-bit and PHE encrypted performed on the server. MatMul is matrix multiplication, which can be in 1-bit format, PHE encoded and performed on the server 504.

Compared with regular transformers or other 1-bit LLMs such as BitNet, architecture 500 keeps components high-precision, e.g., 8-bit. In other words, in the BitNet system, 1-bit transformers are trained from scratch (not converted). However, in the present disclosure input and output vectors are still in floating point format (FP16). This is for multiple reasons. First, the residual connections and the layer normalization contribute negligible computation costs to LLMs. Second, the computational cost of QKV transformation is much smaller than the parametric projection as the model grows larger. Third, the precision is preserved for the input/output embedding because the language models have to use high-precision probabilities to perform sampling.

In some aspects, only linear layers are quantized (i.e., in 1-bit format). The quantization is performed per tensor during training while per token during inference for both stability and efficiency.

FIG. 7 is a block diagram 700 of a generalized example for performing LLM operations using a client device and a service provider. In diagram 700, initial operations and data 702, addition operations 704, complex operations 706, and addition operations 708 are all part of an LLM. For example, the operations may be performed in different layers of the LLM.

Initial operations and data 702 are performed on client device 502. Because addition operations 704 is compatible with PHE, client device 502 may encrypt the input of operations 704 using PHE and transmit them to server 504. The results of operations 704 are returned to client device 502, which may then decrypt the result and perform complex operations 706 that are incompatible with PHE. Because addition operations 708 are compatible with PHE, the results of operations 706 may be encrypted using PHE and transmitted to server 504. Server 504 ultimately transmits result 710 to client device 502, which decrypts the result for presentation to a user.

In some aspects, the first operation comprises computing a square root of a number via series expansion using addition and multiplication operations. In general-case square root calculation for scaled dot-product attention in low-precision transformer inference, a series-based realization can be employed without reliance on full-precision computation throughout the pipeline. A method is provided to apply a scaling factor s=1/√(d_k) while retaining binarized weight and activation paths for the heavy tensor operations. The method comprises precomputing the per-head scale s outside the 1-bit path using multi-bit accumulators, with d_k known and constant per head, by computing s once during initialization or offline via a low-degree polynomial approximation evaluated using Horner's method, a lookup from precomputed values, or a power-of-two approximation with m such that s≈2\hat{ }m; the selected s is stored per head as a small higher-precision constant (e.g., FP16 or fixed-point int16). During attention computation, binary projections are performed such that Q=sign(X W_Q), K=sign(X W_K), and V=sign(X W_V), producing 1-bit activations and enabling binary multiplications in the projection path. Query-key dot products are computed using an XNOR plus popcount kernel (alternatively sign multiplication plus sum), with the resultant popcount or sum accumulated in a multi-bit accumulator (e.g., int16 or int32). The stored scale s is then applied to the multi-bit dot-product accumulator by multiplication in higher precision or, where s is a power of two approximation, by bit-shift on the accumulator. Softmax is executed in higher precision, with FP16 or INT32 logits and exponentiation/summation, and value mixing optionally maintained in low or mixed precision while using accumulators for weighted sums. The method confines non-1-bit arithmetic to precomputation of s, per-logit scaling, and softmax reductions, while preserving 1-bit efficiency for weight and activation storage, binary matrix multiplications in Q/K/V projections, and the XNOR/popcount inner-product kernels. By decoupling square root computation from inference via series expansion or lookup evaluated once per head and by applying the resulting constant scale within the accumulator path, the approach eliminates runtime square root evaluation, maintains binarized throughput for core tensor operations, and achieves accurate scaling of attention logits with minimal precision overhead.

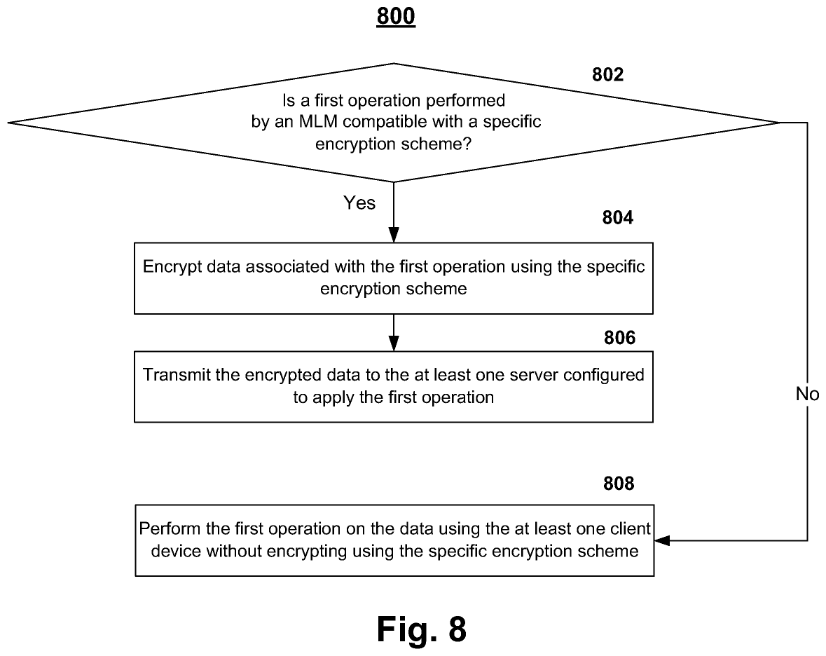

FIG. 8 illustrates method 800 for securely executing an MLM. At 802, module 220 determines whether a first operation performed by an MLM is compatible with a specific encryption scheme. In some aspects, the specific encryption scheme is PHE and the MLM is a 1-bit LLM. It should be noted that in method 800, the MLM is distributed over at least one client device (e.g., client device 502 that is in enterprise network 101) and at least one server (e.g., server 504 that is part of LLM service provider network 102).

Determining the compatibility of a first operation with PHE involves assessing whether the operation can be simplified or transformed into addition operations. This is because PHE schemes typically support a limited set of operations, such as addition, on encrypted data without requiring decryption. For instance, consider matrix multiplication, a common operation in data processing. Matrix multiplication involves a series of multiplications and additions. However, it can be decomposed into a series of addition operations by breaking down the multiplication into repeated addition, which aligns with the capabilities of PHE. Similarly, if the first operation is a linear operation, such as a linear transformation or a linear combination of variables, module 220 can convert this operation into a series of addition operations.

Accordingly, in some aspects, determining whether the first operation is compatible with the specific encryption scheme involves determining whether the first operation can be reduced to one or more addition operations (which are compatible with PHE). Suppose the first operation comprises a linear operation; module 220 may convert the linear operation into one or more addition operations.

In response to determining that the first operation is compatible with the specific encryption scheme, method 800 advances to 804, where module 220 encrypts data associated with the first operation using the specific encryption scheme. At 806, module 220 transmits the encrypted data to the at least one server configured to apply the first operation. For example, addition operations 704 are compatible with PHE, and accordingly the data that serves as an input to addition operations 704 may be encrypted by client device 502 and sent to server 504.

In response to determining, at 802, that the first operation is incompatible with the specific encryption scheme, method 800 advances to 808, where LLM inference module 242 performs the first operation on the data using the at least one client device without encrypting using the specific encryption scheme. In this case, the operation is performed locally. For example, in FIG. 7, initial operations and data 702 may be incompatible with PHE and are performed on client device 502.

In some aspects, the data is input data provided by a user. Accordingly, the at least one client device (e.g., client device 502) may receive a result of the first operation (e.g., operations 704) from the at least one server (e.g., server 504). Client device 502 may then determine a decrypted value from the result using a decryption key (in datastore 221) associated with the specific encryption scheme.

In some aspects, if that is the final result, user interface 210 may output the decrypted value on the at least one client device.

In some aspects, module 220 may also determine whether a second operation (e.g., complex operations 706) performed by the MLM is compatible with the specific encryption scheme. In response to determining that the second operation is incompatible with the specific encryption scheme, LLM inference module 242 may perform the second operation on the decrypted value using the at least one client device without encrypting using the specific encryption scheme.

Suppose that second operation is also a compatible with the specific encryption scheme. In this case, rather than decrypting the first result and performing encryption again, the second operation may also be performed on a result of the first operation applied to the encrypted data.

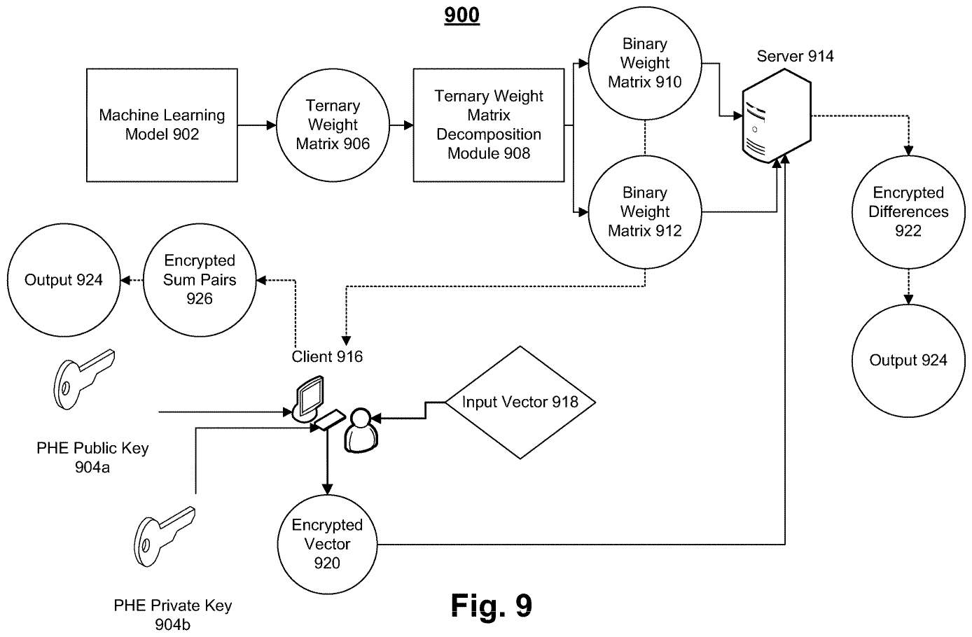

FIG. 9 illustrates a system 900 for performing secure inference of an MLM 902 using PHE, in which ternary weight matrices of the MLM 902 are decomposed into binary matrices and linear operations are computed over encrypted data via homomorphic addition in a client-server architecture. System 900 may be executed by one or more computer systems 20 described in FIG. 11.

In some aspects, the MLM 902 may comprise a neural network architecture such as a transformer-based language model, a convolutional neural network for image classification, a recurrent neural network for sequence prediction, or any other model architecture that includes one or more linear layers parameterized by weight matrices. The MLM 902 may include at least one linear operation represented by a weight matrix A whose elements are constrained to the ternary set {−1, 0, +1}. The PHE scheme may support at least homomorphic addition of ciphertexts, thereby enabling certain arithmetic operations to be performed directly on encrypted data without requiring decryption. In some aspects, the PHE scheme may comprise a Paillier cryptosystem, an Elgamal variant supporting additive homomorphism, or any other encryption scheme that permits homomorphic addition of ciphertexts while preserving semantic security.

Although the following description refers primarily to partially homomorphic encryption as a preferred embodiment, the disclosed techniques are not limited to PHE and may be practiced with any encryption scheme that supports at least homomorphic addition of ciphertexts. For example, a fully homomorphic encryption (FHE) scheme, a somewhat homomorphic encryption (SWHE) scheme, or a leveled homomorphic encryption scheme may each be used in an additive-only mode to carry out the homomorphic summation operations described herein. Because the disclosed methods require only homomorphic addition—and, optionally, homomorphic negation—any such scheme that provides these capabilities is sufficient to implement the techniques described below.

Initially, a public key and a private key for the PHE scheme may be generated by an encryption/decryption module 220 executing on the at least one client device 916 or on a trusted key generation server. The encryption/decryption module 220 may accept as input a security parameter (e.g., a key length of 2048 bits or 4096 bits) and may output a corresponding public/private key pair. The public key may be used to encrypt plaintext values into ciphertexts, and the private key may be used to decrypt ciphertexts back into plaintext values. Following key generation, one or more linear layers of the MLM may be selected for secure remote execution. The selected linear layers may include, for example, feed-forward layers, attention projection layers (such as query, key, and value projection matrices in a transformer architecture), embedding layers, or other layers whose computations are dominated by linear operations. For each selected linear layer, a corresponding ternary weight matrix A may be obtained.

The ternary weight matrix A may have been derived through one or more training or quantization techniques. In some aspects, the MLM may be trained using quantization-aware training, in which the weight values are constrained to the ternary set {−1, 0, +1} during forward and backward passes of the training process. The training dataset may comprise, for example, a corpus of natural language text (e.g., for a language model), a collection of labeled images (e.g., for an image classifier), or any other dataset appropriate to the task of the MLM. During quantization-aware training, a full-precision weight matrix may be projected onto the ternary set at each training step using a thresholding function, such that weights above a positive threshold are mapped to +1, weights below a negative threshold are mapped to −1, and weights between the thresholds are mapped to 0. Alternatively, in some aspects, a pre-trained full-precision MLM may undergo post-training quantization, in which each weight matrix is converted to a ternary representation by applying a deterministic or stochastic rounding scheme. The resulting ternary weight matrix A may have each element A_{ij} belonging to the set {−1, 0, +1}.

Accordingly, the offline setup may produce a PHE public/private key pair 904 and one or more ternary weight matrices 906 (A) corresponding to the selected linear layers.

In some aspects, a ternary weight matrix decomposition module 908 may receive as input a ternary weight matrix 906 (A) having elements A_{ij}∈{−1, 0, +1}. The decomposition module 908 may decompose the ternary weight matrix A into two binary matrices that, when applied to an input vector, collectively reproduce the result of the original ternary matrix-vector product without requiring any multiplications. As an illustrative example, consider a ternary weight matrix A of dimension 3×4 given by:
A=[[+1, −1, 0, +1], [0, +1, +1, 0], [−1, 0, +1, −1]].

To begin the decomposition, a first binary matrix A\hat{ }{(+)} may be constructed such that A\hat{ }{(+)}{ij}=1 if A{ij}=+1, and A\hat{ }{(+)}_{ij}=0 otherwise. Continuing the illustrative example, the first binary matrix A\hat{ }{(+)} may be:
A\hat{ }{(+)}=[[1, 0, 0, 1], [0, 1, 1, 0], [0, 0, 1, 0]].

Additionally, a second binary matrix A\hat{ }{(−)} may be constructed such that A\hat{ }{(−)}{ij}=1 if A{ij}=−1, and A\hat{ }{(−)}_{ij}=0 otherwise. Continuing the illustrative example, the second binary matrix A\hat{ }{(−)} may be:
A\hat{ }{(−)}=[[0, 1, 0, 0], [0, 0, 0, 0], [1, 0, 0, 1]].

Based on these constructions, for any input vector x, the ternary matrix-vector product A·x may be expressed as the difference A\hat{ }{(+)}·x−A\hat{ }{(−)}·x. Each of the products A\hat{ }{(+)}·x and A\hat{ }{(−)}·x may be computed as a sum of selected components of x, determined by the positions of the ones in A\hat{ }{(+)} and A\hat{ }{(−)}, respectively, without requiring any multiplications. Continuing the illustrative example with an input vector x=(x_1, x_2, x_3, x_4), the first row of A\hat{ }{(+)}·x would yield x_1+x_4 (summing only the components where A\hat{ }{(+)}{1j}=1), and the first row of A\hat{ }{(−)}·x would yield x_2 (summing only the component where A\hat{ }{(−)}{1j}=1). The difference for the first row would thus be (x_1+x_4)−x_2, which corresponds to the result of multiplying the first row of A by x, namely (+1)·x_1+(−1)·x_2+(0)·x_3+(+1)·x_4. This property may be advantageous in a homomorphic encryption context because the computation of each partial product reduces to repeated homomorphic addition of ciphertexts, thereby avoiding the need for homomorphic multiplication operations that are not supported by the PHE scheme.

The decomposition may thus yield a first binary matrix 910 (A\hat{ }{(+)}), a second binary matrix 912 (A\hat{ }{(−)}), and a relation indicating that the ternary matrix-vector product A·x is equal to the difference between the contributions defined by A\hat{ }{(+)} and A\hat{ }{(−)}. In some aspects, the ternary weight matrix decomposition module 908 may execute as an offline preprocessing step on the at least one client device 916, on the at least one server 914, or on a separate trusted computing device prior to any encrypted inference. Because the decomposition module 908 operates on the plaintext ternary weight matrix 906, which does not contain private user data, the decomposition may be performed without encryption on any computing device that has access to the model weights. Following execution, the decomposition module 908 outputs the first binary matrix 910 and the second binary matrix 912, which are then distributed to the at least one server 914 as described below.

In some aspects, the binary matrices and encryption keys produced during the offline setup and decomposition phases may be distributed among one or more computing devices to enable a secure client-server computation protocol.

The first binary matrix 910 (A\hat{ }{(+)}) and the second binary matrix 912 (A\hat{ }{(−)}) may be stored on at least one server 914. The at least one server 914 may comprise one or more cloud computing instances, dedicated inference servers, edge computing nodes, or other remote computing resources accessible over a communication network such as the Internet, a local area network, or a wireless network. The at least one server 914 may be configured to perform homomorphic addition on ciphertexts received from a client device. Separately, the PHE private key 904b may be stored on the at least one client device 916. The at least one client device 916 may comprise a smartphone, a tablet, a laptop computer, a desktop computer, a wearable device, an embedded system, or any other computing device capable of performing encryption and decryption operations. The at least one client device 916 may retain the PHE private key 904b in secure storage, such as a hardware security module, a trusted execution environment, a secure enclave, or an encrypted keystore, to ensure that decryption capabilities remain exclusively under the control of the client. The PHE public key 904a may also be stored on the at least one client device 916 and, optionally, on the at least one server 914. In aspects where the public key 904a is provided to the at least one server 914, the server may use the public key 904a to perform certain homomorphic operations, such as encrypting constant values or computing homomorphic negations.

Following distribution, the at least one server 914 may hold the binary matrices A\hat{ }{(+)} and A\hat{ }{(−)}, and the at least one client device 916 may hold the PHE private key 904b and may be capable of encrypting data using the public key 904a.

In some aspects, the at least one client device 916 may receive or generate a plaintext input vector 918, denoted x=(x_1, . . . , x_n), corresponding to an input for a selected linear layer of the MLM. The plaintext input vector 918 may be derived from data provided by a user through a user interface of the at least one client device 916, such as a text input field in a chat application (e.g., for a language model), an image captured by a camera (e.g., for an image classification model), an audio signal recorded by a microphone (e.g., for a speech recognition model), or sensor readings from an embedded device. In some aspects, the plaintext input vector 918 may represent an intermediate activation produced by a preceding non-linear layer of the MLM that was executed locally on the at least one client device 916. Each element x_j of the plaintext input vector 918 may be an integer or a fixed-point representation of a real number, encoded in a format compatible with the plaintext space of the PHE scheme.

For each element x_j of the plaintext input vector 918, the at least one client device 916 may compute a ciphertext c_j=Enc(x_j) using the PHE public key 904a. The at least one client device 916 may then form an encrypted input vector 920, denoted c=(c_1, . . . , c_n), comprising the individual ciphertexts. Once formed, the at least one client device 916 may transmit the encrypted input vector 920 (c) to the at least one server 914 over a communication network, such as a Transport Layer Security (TLS) encrypted connection over the Internet, a secure wireless link, or any other suitable communication channel. Because each element of the input vector is individually encrypted under the PHE scheme, the at least one server 914 may not have access to any plaintext values of x, thereby preserving the confidentiality of the client's input data even if the server or the communication channel is compromised.

The resulting encrypted input vector 920 (c) may then be available for server-side processing.

In some aspects, the at least one server 914 may receive the encrypted input vector 920, denoted c=(c_1, . . . , c_n), and may perform homomorphic computations using the binary matrices 910 (A\hat{ }{(+)}) and 912 (A\hat{ }{(−)}) stored thereon.

For each row index i of the binary matrices, the at least one server 914 may first determine an index set J\hat{ }{(+)}i={j|A\hat{ }{(+)}{ij}=1}, representing the positions in row i of the first binary matrix A\hat{ }{(+)} that have a value of one. Using homomorphic addition of the PHE scheme, the at least one server 914 may then compute an encrypted positive sum S\hat{ }{(+)}i=⊕{j∈J\hat{ }{(+)}_i} c_j, where ⊕ denotes repeated homomorphic addition over the ciphertexts indexed by J\hat{ }{(+)}_i. In pseudocode, for each row i, the server may initialize S\hat{ }{(+)}_i to an encryption of zero and then, for each index j in J\hat{ }{(+)}_i, update S\hat{ }{(+)}_i by performing a homomorphic addition of SZ\hat{ }{(+)}_i and c_j, such that after processing all indices in J\hat{ }{(+)}_i, the resulting ciphertext S\hat{ }{(+)}i encrypts the sum of the plaintext values x_j for all j where A\hat{ }{(+)}{ij}=1. Similarly, the at least one server 914 may determine an index set J\hat{ }{(−)}i={j|A\hat{ }{(−)}{ij}=1}, representing the positions in row i of the second binary matrix A\hat{ }{(−)} that have a value of one. The at least one server 914 may then compute, using homomorphic addition, an encrypted negative sum S\hat{ }{(−)}i=⊕{j∈J\hat{ }{(−)}_i} c_j.

Furthermore, for positions where both A\hat{ }{(+)}{ij}=0 and A\hat{ }{(−)}{ij}=0, the at least one server 914 may omit homomorphic summation operations, thereby skipping contributions of zero-valued weights and reducing the computational burden on the server. In some aspects, the sparsity of the ternary weight matrix A (i.e., the proportion of zero-valued entries) may be significant, and this selective omission may result in a substantial reduction in the number of homomorphic addition operations performed per row. For example, if a given row of A contains 70% zero entries, only 30% of the ciphertexts in the encrypted input vector 920 need to be involved in homomorphic summations for that row.

Depending on the capabilities of the PHE scheme, the at least one server 914 may proceed according to one of at least two options. Under Option A (server-side difference), the at least one server 914 may compute an encrypted difference 922, denoted D_i=Diff(S\hat{ }{(+)}_i, S\hat{ }{(−)}_i), where Diff(·, ·) may be implemented using homomorphic operations supported by the PHE scheme. For example, the encrypted difference D_i may be computed by performing a homomorphic addition of S\hat{ }{(+)}_i and a homomorphic negation of S\hat{ }{(−)}_i. The at least one server 914 may then transmit D_i to the at least one client device 916. Under Option B (client-side difference), the at least one server 914 may transmit both encrypted sums S\hat{ }{(+)}_i and S\hat{ }{(−)}_i to the at least one client device 916 without computing the difference on the server.

Accordingly, the server-side computation may produce, under Option A, encrypted differences 922 (D_i), or under Option B, encrypted sum pairs 926 (S\hat{ }{(+)}_i, S\hat{ }{(−)}_i).

In some aspects, the at least one client device 916 may receive, from the at least one server 914, either the encrypted differences 922 (D_i) under Option A or the encrypted sum pairs 926 (S\hat{ }{(+)}_i and S\hat{ }{(−)}_i) under Option B. The at least one client device 916 may use the PHE private key 904b to recover the plaintext result of the ternary matrix-vector product.

Under Option A (server-side difference), for each row index i, the at least one client device 916 may decrypt D_i to obtain z_i=Dec(D_i), where z_i represents the result of the ternary matrix-vector product for row i.

Under Option B (client-side difference), for each row index i, the at least one client device 916 may decrypt S\hat{ }{(+)}_i to obtain p\hat{ }{(+)}_i=Dec(S\hat{ }{(+)}_i) and may decrypt S\hat{ }{(−)}_i to obtain p\hat{ }{(−)}_i=Dec(S\hat{ }{(−)}_i). The at least one client device 916 may then compute z_i=p\hat{ }{(+)}_i−p\hat{ }{(−)}_i.

Once all row results have been obtained, the at least one client device 916 may form a plaintext output vector 924, denoted z=(z_1, . . . , z_m), comprising the computed values z_i for all row indices. The plaintext output vector z may then be used as the output of the linear operation within the MLM. The at least one client device 916 may then perform subsequent non-linear operations locally on the client device. Such non-linear operations may include, for example, applying an activation function (such as a rectified linear unit (ReLU), a Gaussian error linear unit (GELU), or a sigmoid function), performing layer normalization or batch normalization, computing a softmax operation for attention mechanisms in a transformer architecture, or applying dropout during training. Because these non-linear operations are performed on the at least one client device 916 using plaintext values, the non-linear operations do not require homomorphic computation and may be executed efficiently without encryption overhead.

Alternatively, the at least one client device 916 may re-encrypt the plaintext output vector z for further PHE-compatible linear operations on the at least one server 914, thereby enabling a multi-layer secure inference pipeline in which successive linear layers of the MLM are computed remotely while non-linear operations remain under the control of the client. In some aspects, this iterative process of encrypting an input vector, transmitting the encrypted input vector to the server for homomorphic linear computation, receiving encrypted results, decrypting the results, performing non-linear operations, and re-encrypting for the next linear layer may be repeated for each linear layer of the MLM that has been selected for secure remote execution. Upon completion of all layers, the at least one client device 916 may present the final inference result to a user through a user interface, such as displaying generated text in a chat interface, presenting a classification label on a display screen, outputting synthesized audio through a speaker, or transmitting the result to a downstream application or service via an application programming interface (API).

The final result of the client-side decryption and difference computation may be the plaintext output vector 924, where z=A·x. The plaintext output vector 924 may be mathematically equivalent to the result that would have been obtained by computing the ternary matrix-vector product directly on the plaintext input vector, thereby ensuring correctness of the secure inference pipeline while maintaining the confidentiality of the client's input data throughout the computation.

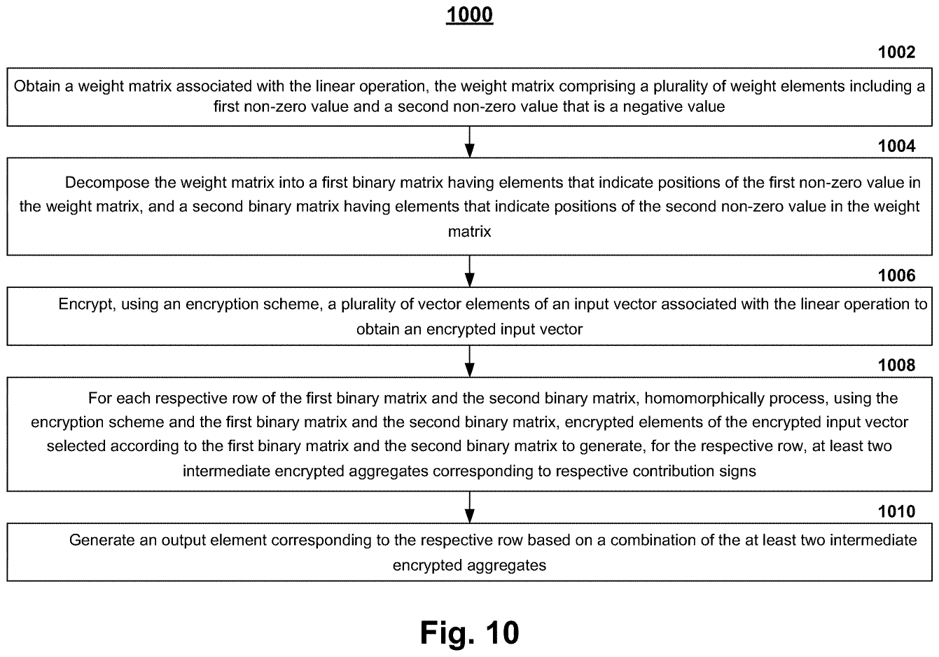

FIG. 10 illustrates a method 1000 for performing secure inference of an MLM 902 using PHE, in which ternary weight matrices of the MLM 902 are decomposed into binary matrices and linear operations are computed over encrypted data via homomorphic addition in a client-server architecture.

As an illustrative example, consider a 1-bit LLM having a single ternary linear layer parameterized by a 3×4 weight matrix A with elements in {−1, 0, +1}. A client device 916 holds a PHE key pair (public key 904a, private key 904b) and a plaintext input vector x=(3, 7, 2, 5). A server 914 stores the binary decomposition matrices derived from A and performs homomorphic computations on encrypted data received from the client device 916.

At 1002, the at least one client device 916 obtains, via the ternary weight matrix decomposition module 908, a weight matrix 906 associated with the linear operation, the weight matrix 906 comprising a plurality of weight elements including a first non-zero value and a second non-zero value that is a negative value (e.g., of the first non-zero value).

Continuing the illustrative example, the decomposition module 908 obtains the following ternary weight matrix 906: A=[[+1, −1, 0, +1], [0, +1, +1, 0], [−1, 0, +1, −1]]. Here, the first non-zero value is +1 and the second non-zero value is −1.

At 1004, the at least one client device 916 decomposes, via the ternary weight matrix decomposition module 908, the weight matrix 906 into a first binary matrix 910 having elements that indicate positions of the first non-zero value in the weight matrix 906, and a second binary matrix 912 having elements that indicate positions of the second non-zero value in the weight matrix 906.

Continuing the illustrative example, the decomposition module 908 produces: A\hat{ }{(+)}=[[1, 0, 0, 1], [0, 1, 1, 0], [0, 0, 1, 0]] as the first binary matrix 910 (marking positions where A has +1), and A\hat{ }{(−)}=[[0, 1, 0, 0], [0, 0, 0, 0], [1, 0, 0, 1]] as the second binary matrix 912 (marking positions where A has −1). The binary matrices 910 and 912 are then stored on the server 914.

At 1006, the at least one client device 916 encrypts, using an encryption scheme, a plurality of vector elements of a plaintext input vector 918 associated with the linear operation to obtain an encrypted input vector 920.

Continuing the illustrative example, the client device 916 receives the plaintext input vector 918, x=(3, 7, 2, 5), and encrypts each element using the PHE public key 904 a to produce the encrypted input vector 920, c=(Enc(3), Enc(7), Enc(2), Enc(5)). The client device 916 then transmits c to the server 914.

At 1008, the at least one client device 916 causes, for each respective row of the first binary matrix 910 and the second binary matrix 912, homomorphic processing, using the encryption scheme and the first binary matrix 910 and the second binary matrix 912, of encrypted elements of the encrypted input vector 920 selected according to the first binary matrix 910 and the second binary matrix 912 to generate, for the respective row, at least two intermediate encrypted aggregates corresponding to respective contribution signs.

Continuing the illustrative example, for row 1 (i=1), the server 914 inspects A\hat{ }{(+)} row 1=[1, 0, 0, 1] and selects c_1=Enc(3) and c_4=Enc(5), then computes S\hat{ }{(+)}_1=Enc(3)⊕Enc(5)=Enc(8) via homomorphic addition. The server 914 also inspects A\hat{ }{(−)} row 1=[0, 1, 0, 0] and selects c_2=Enc(7), yielding S\hat{ }{(−)}_1=Enc(7). For row 2 (i=2), the server 914 inspects A\hat{ }{(+)} row 2=[0, 1, 1, 0] and computes S\hat{ }{(+)}_2=Enc(7)⊕Enc(2)=Enc(9), while A\hat{ }{(−)} row 2=[0, 0, 0, 0] yields no selected elements (the server 914 omits this summation). For row 3 (i=3), the server 914 computes S\hat{ }{(+)}_3=Enc(2) from A\hat{ }{(+)} row 3=[0, 0, 1, 0], and S\hat{ }{(−)}_3=Enc(3)⊕Enc(5)=Enc(8) from A\hat{ }{(−)} row 3=[1, 0, 0, 1].

At 1010, the at least one client device 916 generates an output element corresponding to the respective row based on a combination of the at least two intermediate encrypted aggregates to form a plaintext output vector 924.

Continuing the illustrative example, the client device 916 obtains the plaintext output elements by combining the intermediate aggregates for each row: z_1=8−7=1, z_2=9−0=9, and z_3=2−8=−6. The client device 916 forms the plaintext output vector 924, z=(1, 9, −6), which equals A·x.

In some aspects, homomorphically processing the encrypted elements comprises for each respective row of the first binary matrix 910 and the second binary matrix 912: (1) homomorphically summing, using the encryption scheme, encrypted elements of the encrypted input vector 920 selected according to elements of the first binary matrix 910 that indicate positions of the first non-zero value, to obtain a first encrypted sum, and (2) homomorphically summing, using the encryption scheme, encrypted elements of the encrypted input vector 920 selected according to elements of the second binary matrix 912 that indicate positions of the second non-zero value, to obtain a second encrypted sum.

Continuing the illustrative example for row 1, the server 914 performs: (1) initialize S\hat{ }{(+)}1←Enc(0); for each j where A\hat{ }{(+)}{1j}=1: S\hat{ }{(+)}_1←S\hat{ }{(+)}_1⊕c_j; which yields S\hat{ }{(+)}_1=Enc(0)⊕Enc(3)⊕Enc(5)=Enc(8); and (2) initialize S\hat{ }{(−)}1←Enc(0); for each j where A\hat{ }{(−)}{1j}=1: S\hat{ }{(−)}_1←S\hat{ }{(−)}_1⊕c_j; which yields S\hat{ }{(−)}_1=Enc(0)⊕Enc(7)=Enc(7).

In some aspects, the at least one client device 916 obtains the output element corresponding to the respective row by computing, using the encryption scheme, an encrypted subtraction between the first encrypted sum and the second encrypted sum, and decrypting the encrypted subtraction using the PHE private key 904b.

Continuing the illustrative example under Option A for row 1, the server 914 computes an encrypted difference D_1 from S\hat{ }{(+)}_1 and S\hat{ }{(−)}_1 and transmits D_1 to the client device 916. The client device 916 then decrypts: z_1=Dec(D_1)=Dec(Enc(8−7))=1.

In some aspects, the at least one server 914 computes the encrypted subtraction by computing a homomorphic negation of the second encrypted sum using the encryption scheme, and homomorphically adding the first encrypted sum and the homomorphic negation of the second encrypted sum using the encryption scheme, to obtain an encrypted difference 922.

Continuing the illustrative example under Option A for row 1, the server 914 first computes the homomorphic negation Neg(S\hat{ }{(−)}_1)=Neg(Enc(7))=Enc(−7), and then computes D_1=S\hat{ }{(+)}_1⊕Enc(−7)=Enc(8)⊕Enc(−7)=Enc(1).

In some aspects, homomorphically summing to obtain the first encrypted sum and the second encrypted sum and computing of the encrypted subtraction are performed on the at least one server 914. The at least one client device 916 further decrypts the encrypted subtraction on the at least one client device 916 that stores the PHE private key 904b associated with the encryption scheme.

Continuing the illustrative example under Option A, for all rows the server 914 computes D_1=Enc(1), D_2=Enc(9), and D_3=Enc(−6) and transmits these to the client device 916. The client device 916 decrypts each using the private key 904b: z_1=Dec(D_1)=1, z_2=Dec(D_2)=9, z_3=Dec(D_3)=−6.

In some aspects, obtaining the output element corresponding to the respective row comprises decrypting the first encrypted sum to obtain a first plaintext sum, decrypting the second encrypted sum to obtain a second plaintext sum, and subtracting the second plaintext sum from the first plaintext sum.

Continuing the illustrative example under Option B for row 1, the server 914 transmits S\hat{ }{(+)}_1=Enc(8) and S\hat{ }{(−)}_1=Enc(7) to the client device 916. The client device 916 decrypts: p\hat{ }{(+)}_1=Dec(Enc(8))=8, p\hat{ }{(−)}_1=Dec(Enc(7))=7, and then computes z_1=p\hat{ }{(+)}_1−p\hat{ }{(−)}_1=8−7=1.

In some aspects, homomorphically summing to obtain the first encrypted sum and the second encrypted sum is performed on the at least one server 914, and the decrypting of the first encrypted sum and the decrypting of the second encrypted sum and the subtracting of the second plaintext sum from the first plaintext sum are performed on the at least one client device 916 that stores the PHE private key 904b associated with the encryption scheme.

Continuing the illustrative example under Option B for all rows, the server 914 transmits the encrypted sum pairs (S\hat{ }{(+)}_i, S\hat{ }{(−)}_i) for i=1, 2, 3 to the client device 916. The client device 916 decrypts and subtracts locally: z_1=8−7=1, z_2=9−0=9, z_3=2−8=−6.

In some aspects, the combination of the at least two intermediate encrypted aggregates is a difference between aggregates corresponding to positive and negative contribution signs.

Continuing the illustrative example, for each row i, the output z_i=S\hat{ }{(+)}_i−S\hat{ }{(−)}_i, where S\hat{ }{(+)}_i is the aggregate corresponding to the positive contribution sign and S\hat{ }{(−)}_i is the aggregate corresponding to the negative contribution sign. For row 1, z_1=8−7=1; for row 2, z_2=9−0=9; for row 3, z_3=2−8=−6.

In some aspects, the encryption scheme is a partially homomorphic encryption (PHE) scheme. The PHE scheme may be based on a Paillier cryptosystem, and homomorphically processing comprises repeated application of an addition operation defined by the Paillier cryptosystem to ciphertexts corresponding to elements of the encrypted input vector 920.

Continuing the illustrative example, the Paillier cryptosystem defines an addition operation ⊕ on ciphertexts such that Enc(a)⊕Enc(b)=Enc(a+b). For row 1 of A\hat{ }{(+)}, the server 914 computes S\hat{ }{(+)}_1 by repeatedly applying this operation: Enc(3)⊕Enc(5)=Enc(8), without ever decrypting the individual elements.

In some aspects, the encryption scheme is based on a Cheon-Kim-Kim-Song (CKKS) encryption scheme. The CKKS encryption scheme is a type of homomorphic encryption that enables approximate arithmetic operations directly on encrypted data, making it especially suitable for privacy-preserving computations involving real numbers, such as those found in machine learning and data analytics.

In some aspects, the encryption scheme is Torus Fully Homomorphic Encryption (TFHE) scheme. The TFHE scheme supports fast and efficient fully homomorphic operations on encrypted binary data, allowing for secure computation of arbitrary Boolean circuits and non-linear functions without exposing the underlying plaintext.

In some aspects, the elements of the weight matrix 906 comprise values in {−1, 0, +1}, wherein the first non-zero value is +1, the second non-zero value is −1, and wherein: the first binary matrix 910 has an element equal to one where the weight matrix 906 has an element equal to +1, and zero otherwise; and the second binary matrix 912 has an element equal to one where the weight matrix 906 has an element equal to −1, and zero otherwise.

Continuing the illustrative example, element A_{1,1}=+1, so A\hat{ }{(+)}{1,1}=1 and A\hat{ }{(−)}{1,1}=0. Element A_{1,2}=−1, so A\hat{ }{(+)}{1,2}=0 and A\hat{ }{(−)}{1,2}=1. Element A_{1,3}=0, so A\hat{ }{(+)}{1,3}=0 and A\hat{ }{(−)}{1,3}=0.

In some aspects, the MLM 902 is a 1-bit large language model (LLM), and the weight matrix 906 represents weights of a 1-bit linear layer of the 1-bit LLM.

Continuing the illustrative example, the 3×4 ternary weight matrix A=[[+1, −1, 0, +1], [0, +1, +1, 0], [−1, 0, +1, −1]] represents the weights of a single 1-bit linear layer within the 1-bit LLM, where each weight is constrained to the set {−1, 0, +1}.

In some aspects, the at least one server 914 omits homomorphic summing of encrypted elements of the encrypted input vector 920 for positions in a row of the weight matrix 906 where corresponding elements of the first binary matrix 910 and the second binary matrix 912 each indicate absence of the first non-zero value and the second non-zero value.

Continuing the illustrative example, in row 1 of the weight matrix A, element A_{1,3}=0, so A\hat{ }{(+)}{1,3}=0 and A\hat{ }{(−)}{1,3}=0. The server 914 therefore omits c_3=Enc(2) from all homomorphic summations for row 1. Similarly, in row 2, A_{2,1}=0 and A_{2,4}=0, so the server 914 omits c_1=Enc(3) and c_4=Enc(5) for row 2. Additionally, because every element in A\hat{ }{(−)} row 2 is zero, the server 914 omits the entire negative summation for row 2, yielding S\hat{ }{(−)}_2=Enc(0).

In some aspects, the at least one client device 916 performs at least one non-linear operation of the MLM 902 on one or more output elements of the plaintext output vector 924 obtained on the at least one client device 916 without using the encryption scheme. The at least one client device 916 provides a result of the at least one non-linear operation as an input to a subsequent operation of the MLM 902.

Continuing the illustrative example, the client device 916 receives the plaintext output vector 924, z=(1, 9, −6), and locally applies a non-linear activation function, such as ReLU, to obtain ReLU(z)=(1, 9, 0). The client device 916 then re-encrypts this result as (Enc(1), Enc(9), Enc(0)) using the PHE public key 904a and transmits the re-encrypted vector to the server 914 as the encrypted input vector for the next linear layer of the MLM 902.

FIG. 11 is a block diagram illustrating a computer system 20 on which aspects of systems and methods for providing a secure LLM deployment in an enterprise may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 11 above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for computing a linear operation of a machine learning model (MLM), the method comprising:
obtaining a weight matrix associated with the linear operation, the weight matrix comprising a plurality of weight elements including a first non-zero value and a second non-zero value that is a negative value;
decomposing the weight matrix into:
a first binary matrix having elements that indicate positions of the first non-zero value in the weight matrix; and
a second binary matrix having elements that indicate positions of the second non-zero value in the weight matrix;
encrypting, using an encryption scheme, a plurality of vector elements of an input vector associated with the linear operation to obtain an encrypted input vector;
for each respective row of the first binary matrix and the second binary matrix, homomorphically processing, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and
generating an output element corresponding to the respective row based on a combination of the at least two intermediate encrypted aggregates.

2. The method of claim 1, wherein homomorphically processing the encrypted elements comprises for each respective row of the first binary matrix and the second binary matrix:
homomorphically summing, using the encryption scheme, encrypted elements of the encrypted input vector selected according to elements of the first binary matrix that indicate positions of the first non-zero value, to obtain a first encrypted sum; and
homomorphically summing, using the encryption scheme, encrypted elements of the encrypted input vector selected according to elements of the second binary matrix that indicate positions of the second non-zero value, to obtain a second encrypted sum.

3. The method of claim 2, wherein obtaining the output element corresponding to the respective row comprises:
computing, using the encryption scheme, an encrypted subtraction between the first encrypted sum and the second encrypted sum; and
decrypting the encrypted subtraction.

4. The method of claim 3, wherein computing the encrypted subtraction comprises:
computing a homomorphic negation of the second encrypted sum using the encryption scheme; and
homomorphically adding the first encrypted sum and the homomorphic negation of the second encrypted sum using the encryption scheme.

5. The method of claim 3, wherein homomorphically summing to obtain the first encrypted sum and the second encrypted sum and computing of the encrypted subtraction are performed on at least one server; and
decrypting of the encrypted subtraction is performed on at least one client device that stores a private key associated with the encryption scheme.

6. The method of claim 1, wherein the combination of the at least two intermediate encrypted aggregates is a difference between aggregates corresponding to positive and negative contribution signs.

7. The method of claim 1, wherein the encryption scheme is a partially homomorphic encryption (PHE) scheme.

8. The method of claim 7, wherein the PHE scheme is based on a Paillier cryptosystem, and homomorphically processing comprises repeated application of an addition operation defined by the Paillier cryptosystem to ciphertexts corresponding to elements of the encrypted input vector.

9. The method of claim 1, wherein the encryption scheme is based on a Cheon-Kim-Kim-Song (CKKS) encryption scheme.

10. The method of claim 1, wherein the encryption scheme is Torus Fully Homomorphic Encryption (TFHE) scheme.

11. The method of claim 1, wherein:
the elements of the weight matrix comprise values in {−1, 0, +1}, wherein the first non-zero value is +1, the second non-zero value is −1, and wherein:
the first binary matrix has an element equal to one where the weight matrix has an element equal to +1, and zero otherwise; and
the second binary matrix has an element equal to one where the weight matrix has an element equal to −1, and zero otherwise.

12. The method of claim 1, wherein the MLM is a 1-bit large language model (LLM), and the weight matrix represents weights of a 1-bit linear layer of the 1-bit LLM.

13. The method of claim 1, further comprising omitting homomorphic summing of encrypted elements of the encrypted input vector for positions in a row of the weight matrix where corresponding elements of the first binary matrix and the second binary matrix each indicate absence of the first non-zero value and the second non-zero value.

14. The method of claim 1, further comprising:
performing at least one non-linear operation of the MLM on one or more output elements obtained on a client device without using the encryption scheme; and
providing a result of the at least one non-linear operation as an input to a subsequent operation of the MLM.

15. A system for computing a linear operation of a machine learning model (MLM), comprising:
at least one memory; and
at least one hardware processor coupled with the at least one memory and configured, individually or in combination, to:
obtain a weight matrix associated with the linear operation, the weight matrix comprising a plurality of weight elements including a first non-zero value and a second non-zero value that is a negative value;
decompose the weight matrix into:
a first binary matrix having elements that indicate positions of the first non-zero value in the weight matrix; and
a second binary matrix having elements that indicate positions of the second non-zero value in the weight matrix;
encrypt, using an encryption scheme, a plurality of vector elements of an input vector associated with the linear operation to obtain an encrypted input vector;
for each respective row of the first binary matrix and the second binary matrix, homomorphically process, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and
generate an output element corresponding to the respective row based on a combination of the at least two intermediate encrypted aggregates.

16. A non-transitory computer readable medium storing thereon computer executable instructions for computing a linear operation of a machine learning model (MLM), including instructions for:
obtaining a weight matrix associated with the linear operation, the weight matrix comprising a plurality of weight elements including a first non-zero value and a second non-zero value that is a negative value;
decomposing the weight matrix into:
a first binary matrix having elements that indicate positions of the first non-zero value in the weight matrix; and
a second binary matrix having elements that indicate positions of the second non-zero value in the weight matrix;
encrypting, using an encryption scheme, a plurality of vector elements of an input vector associated with the linear operation to obtain an encrypted input vector;
for each respective row of the first binary matrix and the second binary matrix, homomorphically processing, using the encryption scheme and the first binary matrix and the second binary matrix, encrypted elements of the encrypted input vector selected according to the first binary matrix and the second binary matrix to generate, for the respective row, at least two intermediate encrypted aggregates corresponding to respective contribution signs; and
generating an output element corresponding to the respective row based on a combination of the at least two intermediate encrypted aggregates.
